(19) United States
(12) Patent Application Publication
(10) Pub. No.: US 2011/0241982 A1
(43) Pub. Date: Oct. 6, 2011

(54) ELECTRONIC DEVICE CAPABLE OF AUTOMATICALLY ADJUSTING FILE DISPLAYED ON DISPLAY AND METHOD THEREOF

(75) Inventors: WEI-DA YANG, Tu-Cheng (TW); CHEN-HUANG FAN, Tu-Cheng (TW)

(73) Assignee: HON HAI PRECISION INDUSTRY CO., LTD., Tu-Cheng (TW)

(21) Appl. No.: 12/825,538

(22) Filed: Jun. 29, 2010

(30) Foreign Application Priority Data
Apr. 6, 2010 (TW) 99110532

(51) Int. Cl. G09G 5/00

(52) U.S. Cl. 345/156

(57) ABSTRACT

An adjusting method for adjusting a file includes determining a position of a first point of focus on the display and recording the content displayed at the position of the first point of focus when the electronic device is in a steady state, determining a position of a second point of focus according to the movement of the electronic device and the position of the first point of focus on the display, and adjusting the content by moving the content displayed on the first point of focus to the position of the second point of focus. An electronic device for implementing the adjusting method is also provided.

### BACKGROUND

1. Technical Field

The present disclosure relates to electronic devices and, particularly, to an electronic device capable of automatically adjusting how a file is displayed on a display according to detected movement of the electronic device and a method thereof.

2. Description of Related Art

When a user focuses on some particular content, for example, text displayed on a display of an electronic device, any movement of the electronic device may cause the user to inconveniently lose their place.

Therefore, it is desirable to provide an electronic device and method capable of automatically adjusting the file displayed on the display by moving the content being read before the user has time to change their point of focus to another position.

### BRIEF DESCRIPTION OF THE DRAWINGS

The components in the drawing are not necessarily drawn to scale, the emphasis instead being placed upon clearly illustrating the principles of the disclosure.

FIG. 1 is a block diagram of an electronic device in accordance with one embodiment.

FIG. 2 is a block diagram of main function modules implemented by a processing unit of the electronic device of FIG. 1.

FIG. 3 is a schematic diagram showing a file displayed on a display of the electronic device of FIG. 1, particularly highlighting content of the file displayed at a first point of focus.

FIG. 4 is similar to FIG. 3, but showing the electronic device of FIG. 1 moved to another position.

FIG. 5 is similar to FIG. 4, but showing the highlighted content in FIG. 3 not corresponding to a second point of focus on the display after the electronic device of FIG. 1 is moved to another position.

FIG. 6 is similar to FIG. 5, but showing the highlighted content in FIG. 3 adjusted to correspond to the second point of focus on the display.

FIG. 7 is a flowchart of a method for adjusting a file displayed on the display of the electronic device in accordance with one embodiment.

### DETAILED DESCRIPTION

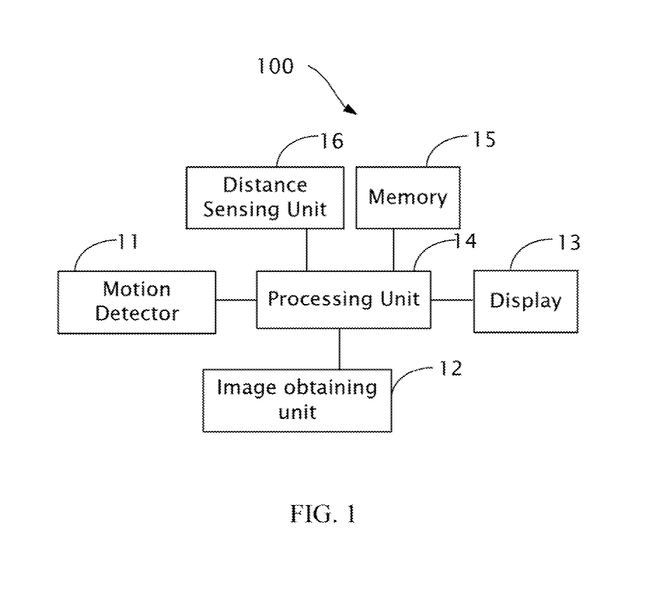

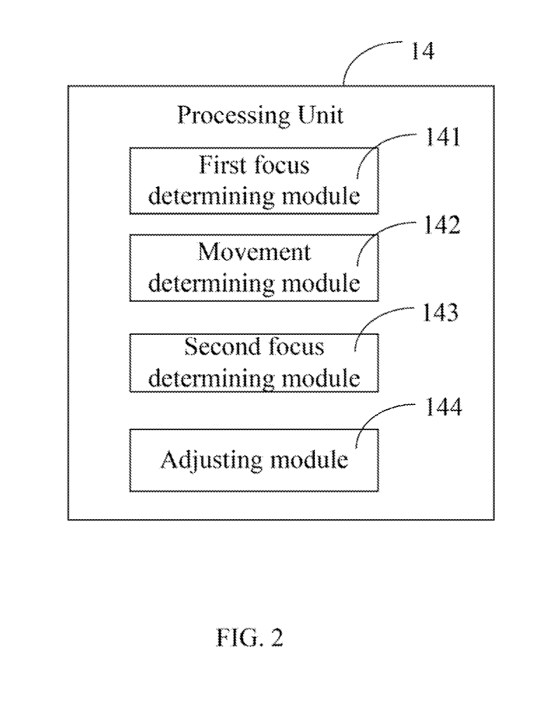

Referring to FIGS. 1 and 2, an electronic device 100 includes a motion detector 11, an image obtaining unit 12, a display 13, a processing unit 14, a memory 15, and a distance sensing unit 16. The motion detector 11, the image obtaining unit 12, the display 13, the memory 15, and the distance sensing unit 16 are electronically connected to the processing unit 14.

The motion detector 11 is configured for periodically detecting movement of the electronic device 100, such as the direction and distance of the movement, so that a new position of the electronic device 100 relative to a user after the movement can be determined. The distance sensing unit 16 is configured for periodically detecting the distance between the head of a user and the electronic device 100. The motion detector 11 can be a g-sensor or an accelerometer. The distance sensing unit 16 can be an infrared sensor. The image obtaining unit 12 is placed at a certain position to periodically obtain an image of the user. The image obtaining unit 12 can be a camera or a vidicon. The display 13 is configured to display files. The memory 15 is configured to store files.

The processing unit 14 includes a first focus determining module 141, a movement determining module 142, a second focus determining module 143, and an adjusting module 144.

While viewing a display, the user's point of focus on the display 13 may change quickly, thus the particular content they are viewing can change from one moment to the next. The first focus determining module 141 is configured to determine a position of the user's point of focus on the display 13 and record the content displayed at that point periodically when the electronic device 100 is in a steady state (held relatively motionless). It should be noted that each time the position of the point of focus is determined and the content displayed at the position is recorded, the previously determined position and recorded content can be deleted, thereby the determined position and recorded content are updated periodically in the steady state. The point of focus in the steady state is called a first point of focus.

A detailed method of determining the position of the first point of focus on the display 13 is disclosed in Chinese publication application NO. CN1889016A published on Jan. 3, 2007, which discloses how to determine the position of the first point of focus on a display according to an image captured of a user's face and the determined distance between the head of the user and the display 13.

The movement determining module 142 is configured to determine whether the electronic device 100 is moved within a predetermined range according to the movement detected by the motion detector 11. The predetermined range is established so that movements that are too small or too large to be adjusted can be ignored.

Initially, when the electronic device 100 moves or is moved quickly, there may be slight delay or reaction time before the user is able to track the movement. Because any movement of the electronic device 100 can be monitored, the position of the second point of focus on the display 13 can be determined so that the content that was being read by the user remains at the same point in space. If the user tries to refocus on a second point in space because of the movement of the device, the user will fail and likely return their attention to their original line of sight.

The second focus determining module 143 is configured to determine the position of the second point of focus according to the movement of the electronic device 100 and the position of the first point of focus, when the movement determining module 142 determines the movement distance is within the predetermined range.

The adjusting module 144 is configured to adjust the content by moving the content of the file displayed at the first point of focus through wrapping, shifting or repositioning to the position of the second point of focus for example.

Therefore, when the movement of the electronic device 100 is within the predetermined range, the electronic device 100 can automatically move the content being read to the position of the new focus on the display 13, so the reader does not need to change the line of sight and search for content they were reading before the movement occurred. In the embodiment, the adjusting module 144 can further highlight the content displayed at the first point of focus on the display 13.

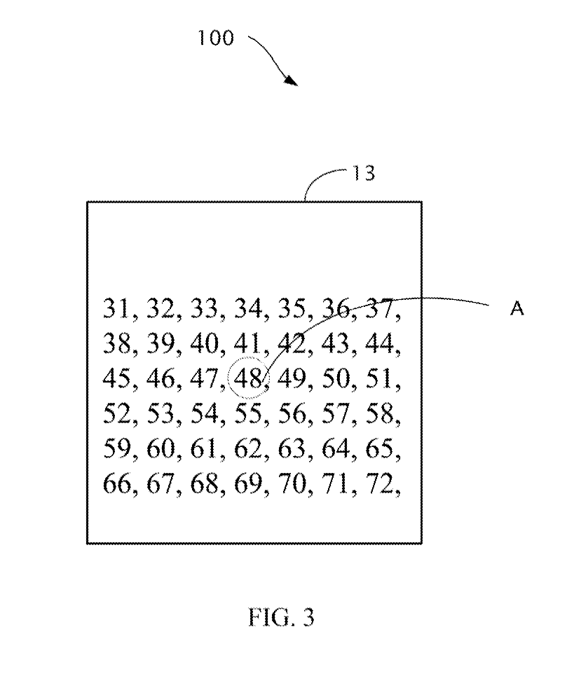

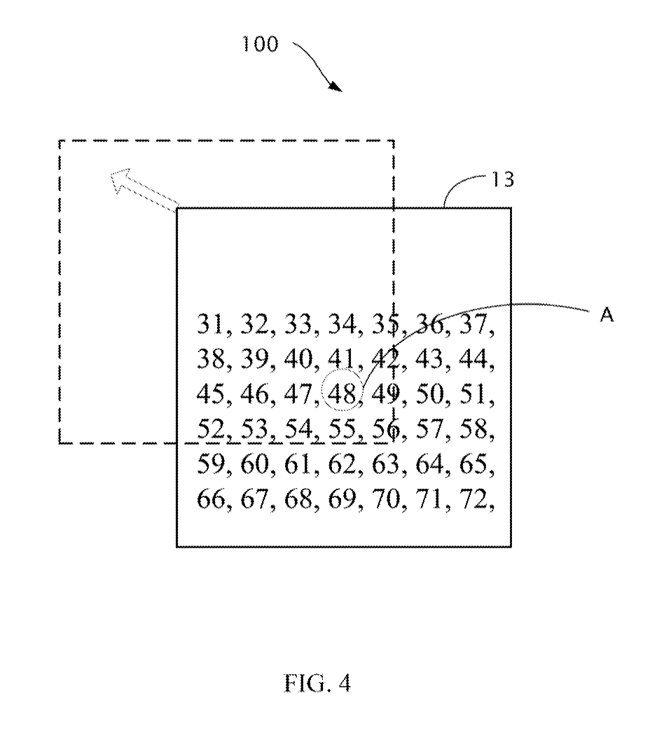

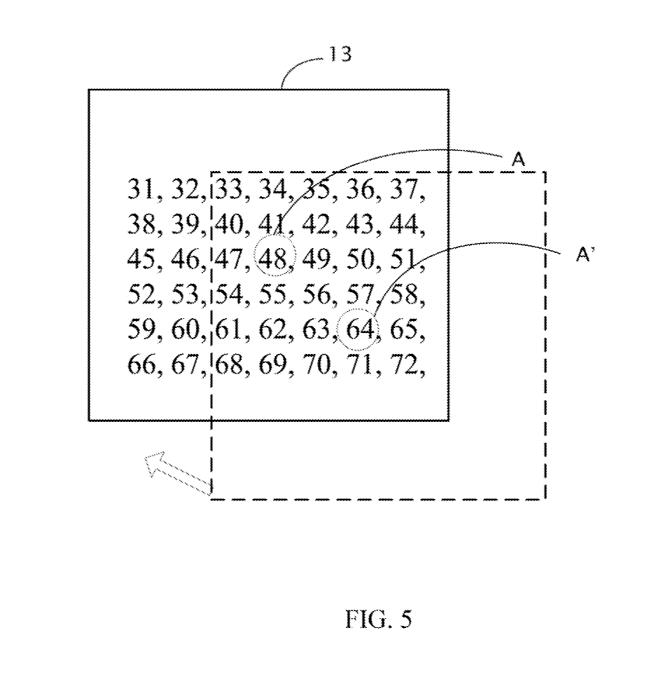

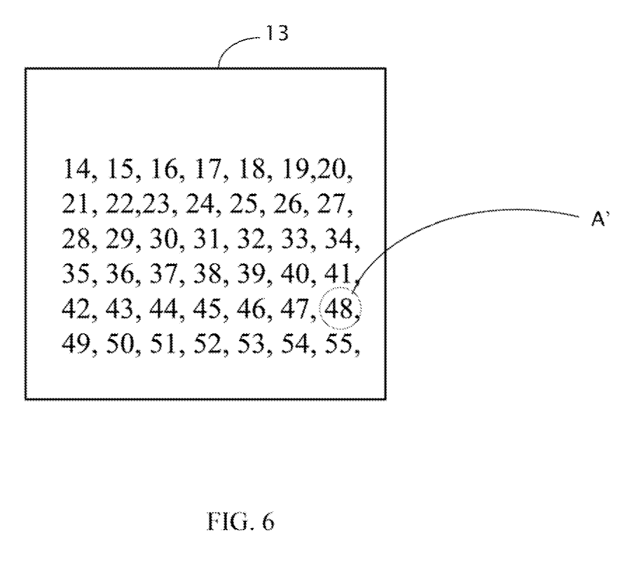

FIGS. 3-6 are employed to illustrate one embodiment of a process of adjusting content displayed on the display 13 when the electronic device 100 is moved. FIG. 3 shows the display 13 displaying one file before movement occurs. The content “48” is corresponding to the first point of focus A which is highlighted. FIG. 4 shows the electronic device 100 moving to another position. FIG. 5 shows the second point of focus changed to A after the electronic device 100 has moved, but the content “48” does not change to correspond to the point of focus A′. FIG. 6 shows the content “48” adjusted to correspond to the point of focus A.

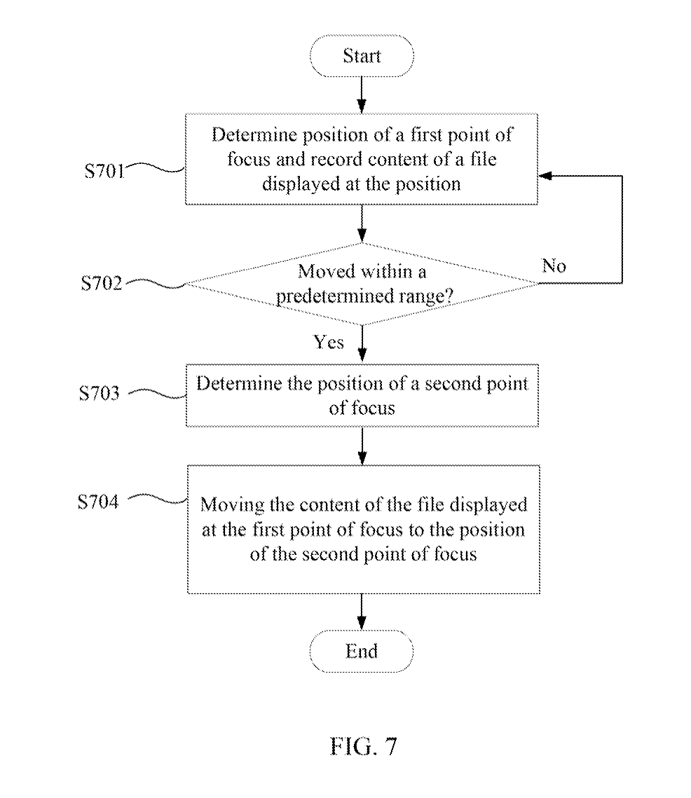

Referring to FIG. 7, the adjusting method is implemented by the processing unit 14 for automatically adjusting the file displayed on the display 13. The adjusting method includes the following steps.

In Step 701, the first focus determining module 141 determines the position of the first point of focus on the display 13 and records the content displayed at the position of the point of focus periodically or continuously when the electronic device 100 is in the steady state. In Step 702, the movement determining module 142 determines whether the electronic device 100 is moved within the predetermined range according to the movement detected by the motion detector 11. If within the predetermined range, the procedure goes to Step 703, and if not, the procedure goes back to Step 701. In Step 703, the new position determining module 143 determines the position of the second point of focus according to the movement of the electronic device 100 and the position of the first point of focus. In Step 704, the adjusting module 144 adjusts the file by moving the content of the file displayed on the first point of focus through wrapping, shifting, repositioning to the position of the second point of focus, or other means to maintain the user's line of sight.

Depending on the embodiment, certain of the steps described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being or exemplary embodiments of the present disclosure.

What is claimed is:

1. An electronic device automatically adjusting content displayed on a display of the electronic device, the electronic device comprising:
a sensing unit sensing a movement of the electronic device; and
a processing unit determining a position of a first point of focus on the display and recording the content displayed at the position of the first point of focus when the electronic device is in a steady state, determining a position of a second point of focus according to the movement of the electronic device and the position of the first point of focus on the display, and adjusting the content by moving the content displayed on the first point of focus to the position of the second point of focus.

2. The electronic device according to claim 1, wherein the sensing unit senses the movement of the electronic device periodically.

3. The electronic device according to claim 1, wherein the processing unit determines the position of the first point of focus on the display and records the content displayed at the position of the first point of focus periodically when the electronic device is in a steady state.

4. The electronic device according to claim 1, further comprising a motion detector, wherein the position of the second point of focus is determined if the electronic device is moved within a predetermined range according to the movement detected by the motion detector.

5. The electronic device according to claim 1, wherein the processing unit highlights the content displayed on the first point of focus.

6. The electronic device according to claim 1, wherein the sensing unit is a g-sensor or an accelerometer.

7. The electronic device according to claim 1, further comprising an image obtaining unit to obtain face images of a user periodically, and a distance sensing unit detecting a distance between a head of the user and the electronic device periodically, wherein the position of the first point of focus is determined according to the obtained face image and the determined distance between the head of the user and the electronic device periodically.

8. The electronic device according to claim 7, wherein the sensing unit is combination of a g-sensor and an infrared sensor.

9. The electronic device according to claim 7, wherein the image obtaining unit is a camera or a vidicon.

10. An adjusting method for adjusting content displayed on a display of an electronic device, the method comprising:
determining a position of a first point of focus on the display and recording the content displayed at the position of the first point of focus when the electronic device is in a steady state;
determining a position of a second point of focus according to the movement of the electronic device and the position of the first point of focus on the display, and
adjusting the content by moving the content displayed on the first point of focus to the position of the second point of focus.

11. The adjusting method according to claim 10, wherein the second point of focus is determined if the electronic device is moved within a predetermined range.

12. The adjusting method according to claim 11, further comprising obtaining face images of the user periodically by an image obtaining unit of the electronic device, detecting a distance between head of a user and the electronic device periodically, and determining the position of the first point of focus according to the obtained face image and the determined distance between the head of the user and the electronic device periodically.

13. An electronic device automatically adjusting content displayed on a display of the electronic device, the electronic device comprising:
a sensing unit sensing a movement of the electronic device periodically; and
a processing unit determining a position of a first point of focus on the display and recording the content displayed at the position of the first point of focus periodically when the electronic device is in a steady state, determining a position of a second point of focus according to the movement of the electronic device and the position of the first point of focus on the display, and adjusting the content by moving the content displayed on the first point of focus to the position of the second point of focus.

14. The electronic device according to claim 13, further comprising a motion detector, wherein the position of the second point of focus is determined if the electronic device is moved within a predetermined range according to the movement detected by the motion detector.

15. The electronic device according to claim 13, wherein the processing unit highlights the content displayed on the first point of focus.

16. The electronic device according to claim 13, wherein the sensing unit is a g-sensor or an accelerometer.

17. The electronic device according to claim 13, further comprising an image obtaining unit to obtain face images of a user periodically, and a distance sensing unit detecting a distance between a head of the user and the electronic device periodically, wherein the position of the first point of focus is determined according to the obtained face image and the determined distance between the head of the user and the electronic device periodically.

18. The electronic device according to claim 13, wherein the sensing unit is combination of a g-sensor and an infrared sensor.

19. The electronic device according to claim 13, wherein the image obtaining unit is a camera or a vidicon.
